(19) United States
(12) Patent Application Publication
(10) Pub. No.: US 2015/0206145 A1
(43) Pub. Date: Jul. 23, 2015

(54) ID MANAGEMENT DEVICE, ID MANAGEMENT METHOD, AND ID MANAGEMENT PROGRAM

(71) Applicant: Rakuten, Inc., Shinagawa-ku Tokyo (JP)

(72) Inventor: Hideaki Tobinai, Shinagawa-ku (JP)

(73) Assignee: RAKUTEN, INC., Shinagawa-ku, Tokyo (JP)

(21) Appl. No.: 14/355,163

(22) PCT Filed: Mar. 29, 2013
(86) PCT No.: PCT/JP2013/059515

§ 371 Date: Apr. 29, 2014

(51) Int. Cl. G06Q 20/40

(52) U.S. Cl. CPC G06Q 20/4014

(57) ABSTRACT

An ID management device according to one embodiment includes a checking unit, a setting unit and a notification unit. The checking unit checks the amount of advance payment made in association with an information processing application. The setting unit sets an available amount already issued or to be set within a credit limit for an applicant of the information processing application in association with ID information corresponding to the applicant to an amount within the amount of advance payment checked by the checking unit. The notification unit notifies the applicant of a setting message indicating that the available amount is set in association with the ID information corresponding to the applicant after the available amount set by the setting unit is reflected on the storage unit.

### TECHNICAL FIELD

One aspect of the present invention relates to a device, a method and a program for managing ID information of a payment means.

### BACKGROUND ART

For a user to whom credit is not granted in the current situation, there are certain needs related to use of a credit card.

For example, for a user to whom credit is not granted in the current situation, there are needs for immediate use of a credit card. To respond to such needs, a scheme that, upon receiving an application for a credit card online, makes determination on approval by making usage and credit facility available only for shopping and immediately notifies a user of a card number and the like is known (cf. Patent Literature 1 below).

Further, for a user whose credit card is suspended for any reason, there are needs for continuous use of the credit card due to the necessity to continue the payment of public utility charges and the like, for example.

### CITATION LIST

### Patent Literature

PTL 1: JP 2005-141771 A

### SUMMARY OF INVENTION

### Technical Problem

However, meeting the above needs results in the raise of a risk for a credit card company that pays the amount of money of sales to a member shop. Accordingly, it is desirable to reduce a risk for a credit card company when allowing a user to whom credit is not granted in the current situation to use a payment means available in the same system as a credit card.

### Solution to Problem

An ID management device according to one aspect of the present invention is an ID management device capable of reflecting setting and change of data on a storage unit accessed by a payment processing device having a function of transmitting approval information only when an inquiry amount contained in inquiry information transmitted from a terminal located in a credit card member shop is equal to or less than an available amount specified from data stored in the storage unit in association with ID information corresponding to a payer related to the inquiry information, a function of changing data stored in the storage unit so that the inquiry amount is reduced from the available amount when the approval information is transmitted, and a function of performing payment processing for paying funds collected from a user corresponding to the ID information to the member shop based on sales information from the member shop, the ID management device including a checking unit configured to check an amount of advance payment made in association with an information processing application, a setting unit configured to set an available amount already issued or to be set within a credit limit for an applicant of the information processing application in association with ID information corresponding to the applicant to an amount within the amount of advance payment checked by the checking unit, and a notification unit configured to notify the applicant of a setting message indicating that the available amount is set in association with the ID information corresponding to the applicant after the available amount set by the setting unit is reflected on the storage unit.

An ID management method according to one aspect of the present invention is an ID management method executed by an ID management device capable of reflecting setting and change of data on a storage unit accessed by a payment processing device having a function of transmitting approval information only when an inquiry amount contained in inquiry information transmitted from a terminal located in a credit card member shop is equal to or less than an available amount specified from data stored in the storage unit in association with ID information corresponding to a payer related to the inquiry information, a function of changing data stored in the storage unit so that the inquiry amount is reduced from the available amount when the approval information is transmitted, and a function of performing payment processing for paying funds collected from a user corresponding to the ID information to the member shop based on sales information from the member shop, the method including a checking step of checking an amount of advance payment made in association with an information processing application, a setting step of setting an available amount already issued or to be set within a credit limit for an applicant of the information processing application in association with ID information corresponding to the applicant to an amount within the amount of advance payment checked in the checking step, and a notification step of notifying the applicant of a setting message indicating that the available amount is set in association with the ID information corresponding to the applicant after the available amount set in the setting step is reflected on the storage unit.

An ID management program according to one aspect of the present invention is an ID management program causing a computer to function as an ID management device capable of reflecting setting and change of data on a storage unit accessed by a payment processing device having a function of transmitting approval information only when an inquiry amount contained in inquiry information transmitted from a terminal located in a credit card member shop is equal to or less than an available amount specified from data stored in the storage unit in association with ID information corresponding to a payer related to the inquiry information, a function of changing data stored in the storage unit so that the inquiry amount is reduced from the available amount when the approval information is transmitted, and a function of performing payment processing for paying funds collected from a user corresponding to the ID information to the member shop based on sales information from the member shop, the program causing the computer to implement a checking unit configured to check an amount of advance payment made in association with an information processing application, a setting unit configured to set an available amount already issued or to be set within a credit limit for an applicant of the information processing application in association with ID information corresponding to the applicant to an amount within the amount of advance payment checked by the checking unit, and a notification unit configured to notify the applicant of a setting message indicating that the available amount is set in association with the ID information corresponding to the applicant after the available amount set by the setting unit is reflected on the storage unit.

A computer-readable recording medium according to one aspect of the present invention stores an ID management program according to one aspect of the present invention is an ID management program causing a computer to function as an ID management device capable of reflecting setting and change of data on a storage unit accessed by a payment processing device having a function of transmitting approval information only when an inquiry amount contained in inquiry information transmitted from a terminal located in a credit card member shop is equal to or less than an available amount specified from data stored in the storage unit in association with ID information corresponding to a payer related to the inquiry information, a function of changing data stored in the storage unit so that the inquiry amount is reduced from the available amount when the approval information is transmitted, and a function of performing payment processing for paying funds collected from a user corresponding to the ID information to the member shop based on sales information from the member shop, the ID management program causing the computer to implement a checking unit configured to check an amount of advance payment made in association with an information processing application, a setting unit configured to set an available amount already issued or to be set within a credit limit for an applicant of the information processing application in association with ID information corresponding to the applicant to an amount within the amount of advance payment checked by the checking unit, and a notification unit configured to notify the applicant of a setting message indicating that the available amount is set in association with the ID information corresponding to the applicant after the available amount set by the setting unit is reflected on the storage unit.

According to the above aspects, the available amount corresponding to ID information is set to be equal to or less than the amount of advance payment by a user, and a message indicating that the setting is done is notified to the applicant. Accordingly, the applicant can use the ID information as a payment means within the available amount. On the other hand, because the available amount is secured by the advance payment by the user, a risk for a credit card company is reduced.

In an ID management device according to another aspect, the information processing application may be an online information processing application, the ID management device may further include a switching unit configured to change the available amount already issued within the amount of advance payment in association with ID information corresponding to an applicant for the information processing application to an amount within a credit limit for the applicant and reflect the change on the storage unit, and the notification unit may notify the applicant of the setting message online before processing by the switching unit is started.

In an ID management device according to another aspect, the online information processing application may be a credit card membership application, the setting unit may set an available amount to be set within a credit limit for an applicant of the membership application in association with ID information corresponding to the applicant to an amount within the amount of advance payment checked by the checking unit, the notification unit may notify the applicant of the setting message containing ID information corresponding to the applicant and attached information online after the available amount set by the setting unit is reflected on the storage unit and before credit examination on the applicant is completed, and the switching unit may change the available amount already issued within the amount of advance payment in association with ID information corresponding to the applicant to an amount within a credit limit for the applicant and reflects the change on the storage unit only when the membership application by the applicant is approved by the credit examination.

In an ID management device according to another aspect, the switching unit may further set an available amount to be newly set within a balance of the available amount already issued in association with ID information corresponding to the applicant in association with new ID information and attached information only when the membership application by the applicant is approved by the credit examination, and the notification unit may further notify the applicant of a transfer setting message containing the new ID information and attached information online after the available amount set in association with the new ID information by the switching unit is reflected on the storage unit.

In an ID management device according to another aspect, the switching unit may change the available amount already issued in association with ID information corresponding to the applicant to an amount within a sum of a credit limit for the applicant and a balance of the already issued available amount and reflect the change on the storage unit only when the membership application by the applicant is approved by the credit examination.

In an ID management device according to another aspect, the notification unit may further notify the applicant of a setting continuation message indicating that the available amount already issued in association with ID information corresponding to the applicant continues to be valid only when the membership application by the applicant is not approved by the credit examination.

In an ID management device according to another aspect, the information processing application may be a switching application for switching a type of the available amount, the setting unit may set an available amount already issued within a credit limit for an applicant of the switching application in association with ID information corresponding to the applicant to an amount within the amount of advance payment checked by the checking unit, and the ID management device may further include a switching unit configured to change the available amount already issued in association with ID information corresponding to the applicant to the amount set by the setting unit and reflect the change on the storage unit.

In an ID management device according to another aspect, the payment processing device may transmit the approval information only when the inquiry amount contained in the inquiry information is equal to or less than an available amount specified from data stored in the storage unit in association with ID information corresponding to a payer related to the inquiry information and when information indicating that the ID information is valid is stored in the storage unit, and the ID management device may further include a receiving unit configured to receive the switching application only when the ID information related to the switching application is already invalid or about to become invalid.

An ID management device according to another aspect may further include an advance notification unit configured to notify a user corresponding to ID information about to become invalid that the ID information is about to become invalid and that the switching application is possible.

### Advantageous Effects of Invention

According to one aspect of the present invention, it is possible to reduce a risk for a credit card company when allowing a user to whom credit is not granted in the current situation to use ID information available in the same system as a credit card.

### BRIEF DESCRIPTION OF DRAWINGS

FIG. 1 is an overall configuration of an ID management system according to an embodiment.

FIG. 2 is a diagram showing an example of card information stored in a database.

FIG. 3 is a diagram showing a hardware configuration of an ID management device according to an embodiment.

FIG. 4 is a block diagram showing a functional configuration according to an embodiment.

FIG. 5 is a sequence chart showing an operation of an ID management device according to a first embodiment.

FIG. 6 is a sequence chart showing an operation of an ID management device according to a second embodiment.

FIG. 7 is a diagram showing a configuration of an ID management program according to an embodiment.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

An ID management system 1 is a computer system that switches a payment means related to a number (card number) of a credit card owned by a user between credit (postpaid payment means) and prepaid (prepaid payment means). With the ID management system 1, a user can switch a payment means from prepaid to credit or from credit to prepaid without changing the card number. Note that, however, when using the prepaid function, the user needs to make advance payment in order to set a limit amount (available amount). The user can use the prepaid function at credit card member shops.

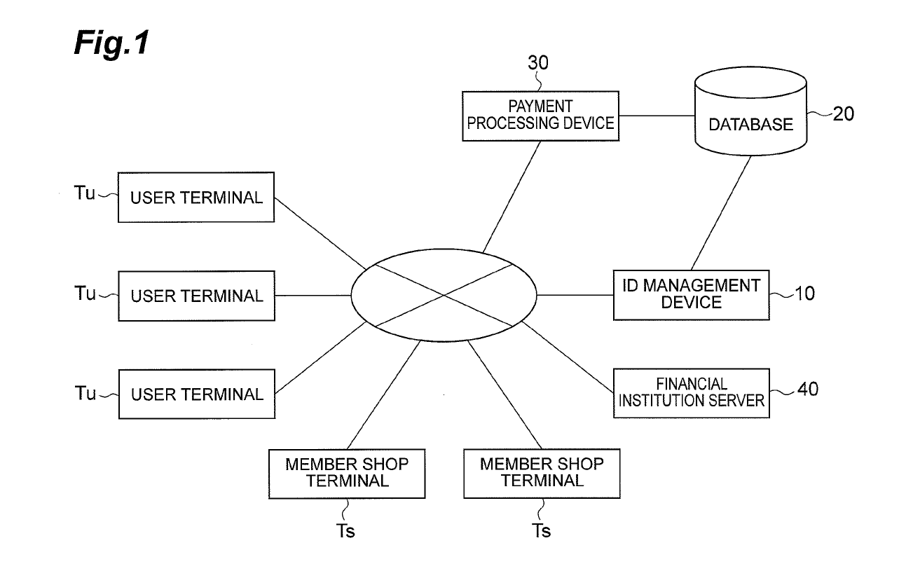

As shown in FIG. 1, the ID management system 1 includes user terminals Tu, an ID management device 10, a database (storage unit) 20, member shop terminals Ts, a payment processing device 30, and a financial institution server 40. The user terminals Tu, the ID management device 10 and the financial institution server 40 are connected with one another through a network such as the Internet. The member shop terminals Ts and the payment processing device 30 are connected with one another through a network such as the Internet or a private line. The ID management device 10 and the payment processing device 30 can directly or indirectly access the database 20 through a network such as the Internet or a private line. The database 20 may be composed of a plurality of storage devices having the function of maintaining synchronization with each other. Note that the number of user terminals Tu and member shop terminals Ts in the ID management system 1 is not limited.

The user terminal Tu is a terminal that is used by a user who applies for or holds a credit card. The variety of the user terminals Tu is not particularly limited, and it may be a stationary or portable personal computer, or a mobile terminal such as an advanced mobile phone (smart phone), a cellular phone or a personal digital assistant (PDA), for example.

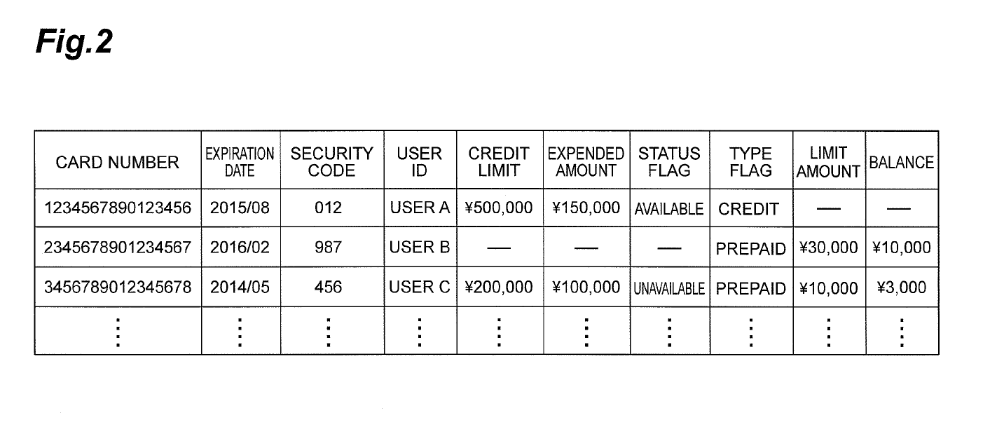

The database 20 is a device that stores card information. The card information is information about a card number that is assigned to a user, and each record of the card information is identified by the card number. As shown in FIG. 2, each record contains the following items. In this specification, the card number corresponds to ID information.
Credit card number (“card number”)
“Expiration date” of the credit function
“Security code” of the card
“User ID” that uniquely identifies a user
“Credit limit” for the current period with the credit function
“Expended amount” for the current period with the credit function
“Status flag” indicating whether the credit function is available
“Type flag” indicating a payment means applied to the card number
“Limit amount” with the prepaid function
“Balance” with the prepaid function

Note that the structure of the card information is not limited. For example, another item may be added to the card information, and the card information may be normalized or made redundant by an arbitrary policy. Further, the card information may contain “available amount” for speeding up and simplification of processing. In the case of calculating the available amount according to the status flag, “(available amount)=(current credit limit)−(current expended amount)” for credit, and (available amount)=(balance) for prepaid.

The member shop terminal Ts is a terminal for making a payment with a credit card, and it is located at a member shop of the credit card. The member shop terminal Ts executes payment processing in coordination with the payment processing device 30.

The payment processing device 30 is a computer that executes payment processing for a credit card. The payment processing device 30 has the following functions.
Function of transmitting approval information only when the inquiry amount contained in inquiry information transmitted from a terminal located in a credit card member shop is equal to or less than the available amount specified from the data stored in the database 20 in association with the card number corresponding to a payer related to the inquiry information. The approval information may be transmitted only when the inquiry amount is equal to or less than the available amount and the card number is valid.
Function of changing the data stored in the database 20 so that the inquiry amount is reduced from the available amount when the approval information is transmitted.
Function of performing payment processing for paying funds collected from a user corresponding to the card number to a member shop based on sales information from the member shop.

The financial institution server 40 is a computer that executes processing for advance payment that is made when a user uses the prepaid function. The variety of the financial institution is not particularly limited, and it may be a bank, an electronic money management company and the like, for example. Further, a method of advance payment and payment processing is not particularly limited.

The ID management device 10 is a computer that manages a payment means corresponding to a card number. The ID management device 10 can reflect setting and change of data on the database 20.

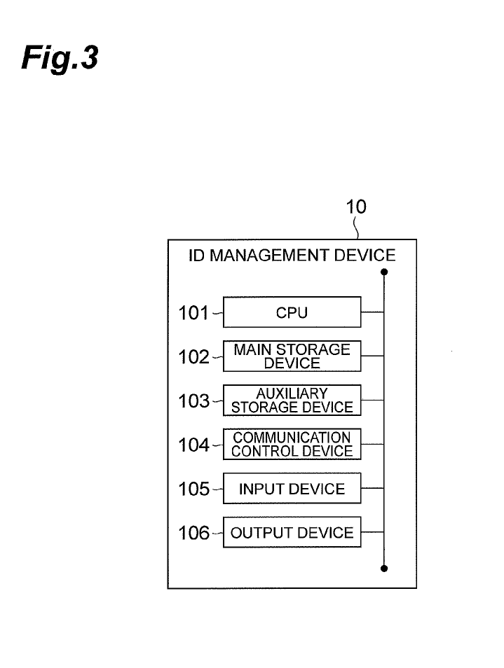

FIG. 3 shows a hardware configuration of the ID management device 10. The ID management device 10 includes one or more CPU 101 that executes an operating system, an application program and the like, a main storage unit 102 such as ROM and RAM, an auxiliary storage unit 103 such as a hard disk and a flash memory, a communication control unit 104 such as a network card or a wireless communication module, an input device 105 such as a keyboard and a mouse, and an output device 106 such as a display.

The functional components of the ID management device 10, which are described later, are implemented by loading given software onto the CPU 101 or the main storage unit 102, making the communication control unit 104, the input unit 105, the output unit 106 and the like operate under control of the CPU 101, and performing reading and writing of data in the main storage unit 102 or the auxiliary storage unit 103. The data and database required for processing are stored in the main storage unit 102 or the auxiliary storage unit 103.

Although the ID management device 10 is composed of one computer in the example of FIG. 3, the ID management device 10 may be composed of a plurality of computers.

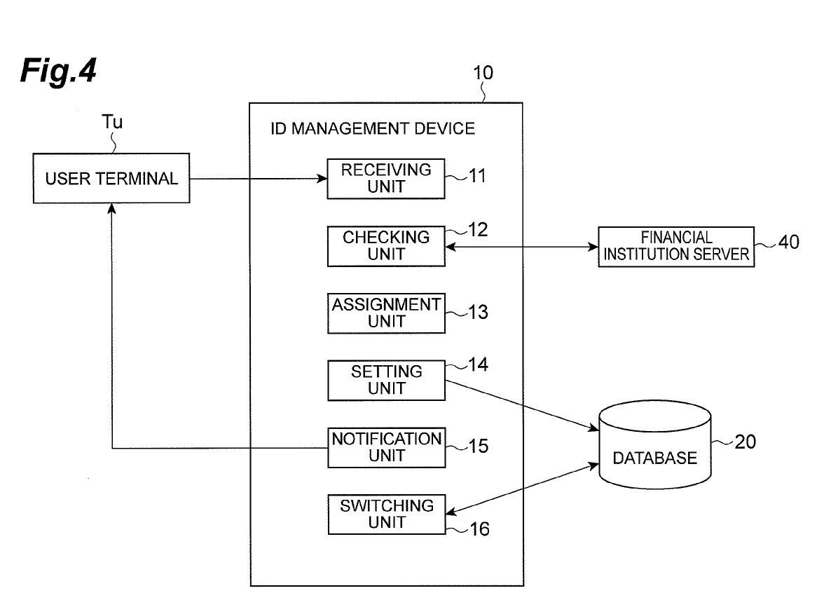

As shown in FIG. 4, the ID management device 10 includes a receiving unit 11, a checking unit 12, an assignment unit 13, a setting unit 14, a notification unit 15, and a switching unit 16 as functional components. The functions of the ID management device 10 are described as two embodiments hereinbelow. A first embodiment is an example of setting the available amount for prepaid that is executed before switching from prepaid to credit. A second embodiment is an example of setting the available amount for prepaid that is executed when switching from credit to prepaid. The ID management device 10 may be able to execute both of the first and second embodiments or execute either one of the two embodiments.

### First Embodiment

The receiving unit 11 is a functional component that receives a credit card membership application from the user terminal Tu. The membership application is one type of an information processing application. The receiving unit 11 may receive information of a membership application (application information) transmitted from the user terminal Tu online or receive application information entered by an operator of the ID management device 10 based on the application sent through the mail. The application information contains personal information such as name, address, phone number, email address, occupation, place of employment, and annual income. After receiving such information, the receiving unit 11 transmits an acknowledgement of receipt of the membership application (acknowledgement of receipt) to the user terminal Tu and outputs the application information to the checking unit 12.

The checking unit 12 is a functional component that checks the amount of advance payment that has been made in association with the membership application. A user makes advance payment to a financial institution by an arbitrary method such as bank transfer. The checking unit 12 inquires the financial institution server 40 about the amount of advance payment by the user and receives information about the amount from the financial institution server 40. The information at least contains information that identifies the user and the amount of advance payment. The checking unit 12 outputs the information as advance payment information, together with the application information, to the setting unit 14.

The assignment unit 13 is a functional component that assigns one card number to a membership application. The assignment unit 13 generates a card number to be issued for an applicant and sets attached information necessary for use of the credit card. Although the attached information contains an expiration date and a security code in this specification, the attached information is not limited thereto. The assignment unit 13 outputs the card number and the attached information, together with the application information, to the setting unit 14.

The setting unit 14 is a functional component that sets the limit amount for the prepaid function corresponding to the card number. The setting unit 14 determines the limit amount so as to satisfy the following conditions.

(Condition 1) The limit amount is within the credit limit with the credit function.

(Condition 2) The limit amount is within the amount of advance payment. For example, the limit amount may be the same as the amount of advance payment or the remaining amount after reducing a prescribed fee from the amount of advance payment.

Note that, however, because credit examination on the membership application is not completed at this point of time, the setting unit 14 may make the determination of the above condition 1 using a predetermined lowest value of the credit limit.

Then, the setting unit 14 generates card information and stores it into the database 20. The setting unit 14 sets a card number, attached information (an expiration date and a security code) and a user ID based on the input information and sets the determined limit amount as the limit amount and the balance for the prepaid function. Because credit examination is not completed at this point of time, the setting unit 14 sets the credit limit, the expended amount and the status flag in the card information to NULL and sets the type flag to “prepaid”.

The notification unit 15 is a functional component that notifies an applicant for a credit card that the limit amount is set in association with the card number.

First, the notification unit 15 generates information email that informs that a card number is assigned and the prepaid function becomes available and transmits the information email to an email address of the applicant. The information email contains one-time password for a user to obtain the card number and attached information.

When, in response to the information email, the applicant accesses a specified webpage through the user terminal Tu and enters the one-time password, and the user terminal Tu transmits the password, the notification unit 15 receives the password and performs authentication. When the password is correct, the notification unit 15 transmits a prepaid settings notification containing a card number and attached information to the user terminal Tu. The prepaid settings notification is a setting message indicating that the limit amount is set to the card number. On the other hand, when the password is not correct, the notification unit 15 transmits a message indicating an authentication failure to the user terminal Tu. With use of the one-time password, the notification unit 15 can securely transmit the card information to the user.

Because the notification unit 15 performs the above processing before the completion of credit examination on the membership application and before the start of processing of the switching unit 16, the applicant for the credit card can use the prepaid function soon after obtaining the card information without waiting for the examination result. When using the prepaid function, the user uses the card number and the attached information in the same manner as when using the credit card.

The switching unit 16 is a functional component that switches a payment means corresponding to the card number from prepaid (prepaid payment means) to credit (postpaid payment means).

First, the switching unit 16 acquires a result of the credit examination on the membership application. The credit examination may be conducted by an employee of a credit card company and, in this case, the switching unit 16 receives a result of the credit examination that is input by an operator. Alternatively, a given computer such as the ID management device 10 may automatically execute a part or all of the credit examination and, in this case also, the switching unit 16 receives a result of the examination.

As a result of the credit examination, when it is determined to issue a credit card (approve an application), the switching unit 16 changes a payment means corresponding to the card number from prepaid to credit. Specifically, the switching unit 16 sets a credit limit, sets an availability flag to “available”, and changes the type flag to “credit” on the card information in the database 20 corresponding to the card number.

Further, when the applicant has passed the credit examination, the credit card company issues a plastic credit card and sends it to the applicant.

When a payment means is switched to credit, the switching unit 16 may execute processing related to the balance of the prepaid function (the balance of advance payment). In the case where the switching unit 16 has this function, the applicant can make effective use of the balance.

For example, the switching unit 16 may generate a virtual prepaid card by issuing a new card number and its attached information (an expiration date and a security code) and associating the amount equal to or less than the balance of advance payment with the card number. In this case, the switching unit 16 generates a transfer setting message containing the new card number and its attached information and transmits the message to the user terminal Tu. As a result, the user can use both of the credit card and the virtual prepaid card.

The virtual prepaid card is a prepaid payment means that is available on the Internet, using the same card number and attached information as the credit card. Although the limit amount needs to be set to use the prepaid card, because the switching unit 16 sets the balance of advance payment as the limit amount, a user does not need to make advance payment again. The virtual prepaid card may be a disposable type with no charge function or may be chargeable. For example, a virtual prepaid card in which the limit amount increases at the beginning of the next period if advance payment is made during the current period may be employed.

Alternatively, the switching unit 16 may add the balance of advance payment to the credit limit of the current period. In this case, the credit limit of that period increases by the amount of the balance of advance payment. Alternatively, the balance of advance payment may be balanced out with the amount billed on the next billing of the credit card. Alternatively, the balance of advance payment may be refunded to the user by an arbitrary method. The switching unit 16 may execute any of those processing according to a user's selection.

On the other hand, when it is determined not to issue a credit card as a result of the credit examination, the switching unit 16 does not switch a payment means. In this case, the credit card company notifies the applicant that the examination has not been passed by an arbitrary means, without issuing and sending a credit card. When the user does not pass the credit examination, the switching unit 16 ends the process at this point, and the notification unit 15 sends a setting continuation message indicating that the available amount already issued in association with the card number corresponding to the applicant continues to be valid to the applicant. In this case, the card number assigned to the user and the attached information remain valid, and therefore the user can continue to use the prepaid function as the virtual prepaid card. Alternatively, the switching unit 16 may make the card number invalid and notify the user that the prepaid function has become disabled. In this case, the balance of advance payment is refunded to the user by an arbitrary method.

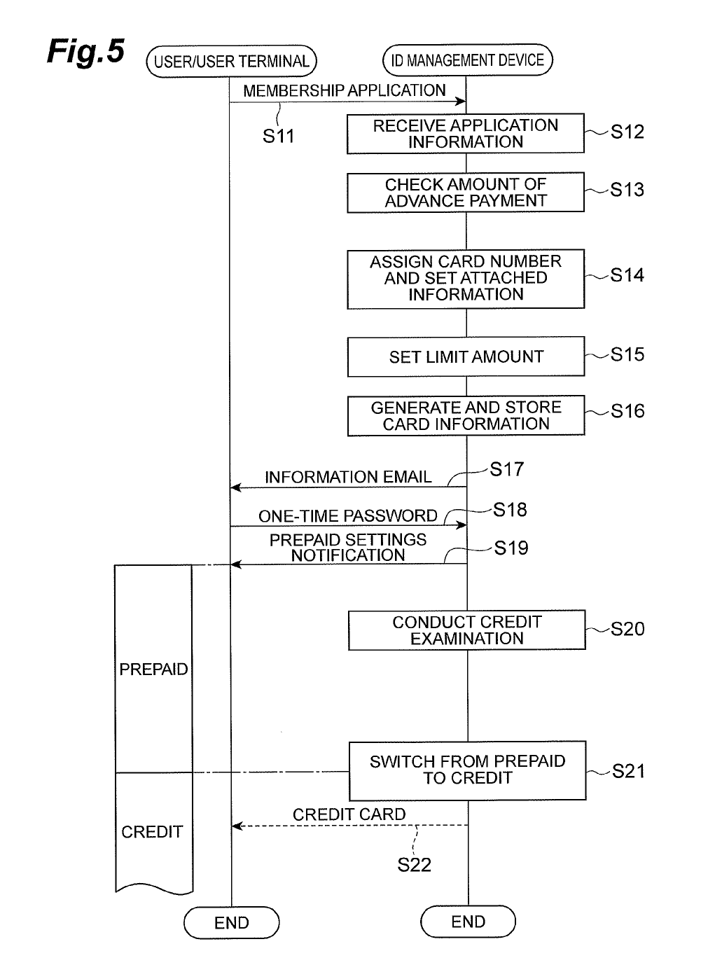

The operation of the ID management system 1 is described and further an ID management method according to this embodiment is described hereinafter with reference to FIG. 5.

First, the receiving unit 11 receives application information according to a membership application from a user (an applicant for a credit card) (Steps S11 and S12). Next, the checking unit 12 makes inquiry to the financial institution server 40 and checks the amount of advance payment (Step S13; checking step). Then, the assignment unit 13 assigns a card number and sets attached information (an expiration date and a security code) (Step S14). After that, the setting unit 14 sets the limit amount for the prepaid function based on the advance payment (Step S15; setting step), generates card information for the card number and stores it into the database 20 (Step S16).

Then, the notification unit 15 transmits information email in which a one-time password is written to the user terminal Tu (Step S17) and, in response to the one-time password transmitted from the user terminal Tu as a response to the above email, transmits a prepaid settings notification to the user terminal Tu (Steps S18 and S19; notification step). The prepaid settings notification contains the card number and attached information. From this point of time, the applicant for the credit card can use the prepaid function with the card number.

After that, credit examination is conducted (Step S20). When it is determined to issue a credit card (approve an application), the switching unit 16 updates the card information in the database 20 and thereby switches a payment means corresponding to the card number from prepaid to credit (Step S21). After the lapse of some time (for example, one day or several days), a plastic credit card is shipped to the applicant (Step S22).

As described above, according to this embodiment, the limit amount corresponding to a card number is set to be equal to or less than the amount of advance payment by a user, and a message indicating that the setting is done is notified to the applicant. Accordingly, the applicant can use the card number as a prepaid payment means within the limit amount. On the other hand, because the limit amount is secured by the advance payment by the user, a risk for a credit card company is reduced.

In the existing system, an applicant cannot know a card number and attached information available for payment until a plastic credit card is delivered and thus cannot make payment using the card number. On the other hand, in this embodiment, an applicant is immediately provided with a set card number and attached information as information of the prepaid function without waiting for the end of credit examination. The applicant can thereby use the card number as a payment means within the limit amount secured by advance payment before obtaining the credit card.

In this embodiment, a payment means for a card number automatically changes from prepaid to credit upon an applicant's passing the credit examination, and therefore the applicant can use the credit function immediately with no need to apply for switching of a payment means.

Although the processing for a credit card membership application is described in the above embodiment, the timing to make switching from prepaid to credit is not limited thereto. For example, the ID management device 10 may accept an application for switching to credit from a user who has changed a payment means for a card number to prepaid after obtaining a credit card. In this case, the switching unit 16 executes the same switching processing as described above.

### Second Embodiment

The receiving unit 11 receives an application for switching from credit to prepaid from the user terminal Tu. The switching application is one type of information processing application. Information of the switching application (application information) contains a user ID and a card number. Note that the receiving unit 11 may specify a user ID from a cookie session ID or the like based on the assumption that a user logs in a service site. The receiving unit 11 may receive the application information (online application information) from the user terminal Tu or may receive the application information entered by an operator of the ID management device 10 based on an application from the user. The receiving unit 11 transmits an acknowledgement of receipt of the switching application (acknowledgement of receipt) to the user terminal Tu and outputs the application information to the checking unit 12.

In this embodiment, an example in which the ID management device 10 executes switching from credit or prepaid in the situation where the credit function of a user is suspended is described. Accordingly, the receiving unit 11 receives a switching application only when a card number is already invalid or about to become invalid.

For example, a credit card is suspended when the expended amount of the credit card cannot be withdrawn from the account on the billing date. As a matter of course, the condition to suspend a credit card is not limited thereto. For example, a credit card can be suspended when another credit card issued by another credit card company is suspended. Although this situation does not seem to be so serious as to immediately suspend the credit card to be processed in this embodiment, there is a case where the credit card needs to become invalid for some rules. This embodiment can be regarded also as a potential remedy for such a case.

The checking unit 12 checks the amount of advance payment that has been made in association with the switching application. The checking unit 12 inquires the financial institution server 40 about the amount of advance payment by the user and outputs advance payment information received from the financial institution server 40, together with the application information, to the setting unit 14, in the same manner as in the first embodiment.

The setting unit 14 sets the limit amount for the prepaid function corresponding to the card number. The setting unit 14 determines the limit amount so as to satisfy the above-described conditions 1 and 2 in the same manner as in the first embodiment. In this embodiment, the credit limit for the user is already set. Thus, the setting unit 14 only needs to read the credit limit corresponding to the card number from the database 20 and make the determination on the condition 1 using the credit limit.

The notification unit 15 sends a prepaid settings notification indicating that the limit amount is set in association with the card number to the user who has made the switching application. Because the user already obtains a credit card in this embodiment, the notification unit 15 only needs to transmit the prepaid settings notification to the user terminal Tu without requiring a one-time password. Note that, however, the notification unit 15 transmits the prepaid settings notification after the switching from credit to prepaid by the switching unit 16 is completed.

The switching unit 16 switches a payment means corresponding to the card number from credit to prepaid. The switching unit 16 changes a payment means corresponding to the card number to prepaid by updating the card information in the database 20 corresponding to the card number. Specifically, the switching unit 16 writes the set limit amount as the limit amount and the balance for the prepaid function and changes the type flag to “prepaid”.

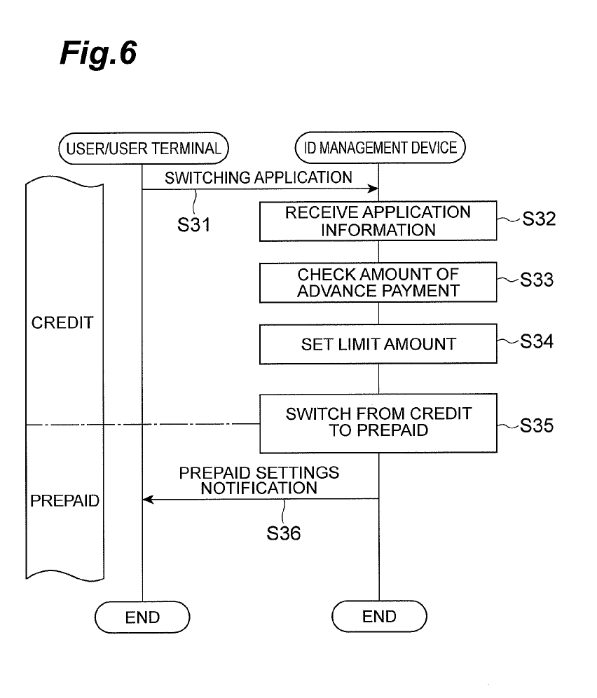

The operation of the ID management system 1 is described and further an ID management method according to this embodiment is described hereinafter with reference to FIG. 6.

First, the receiving unit 11 receives application information according to a switching application from a user (an owner of a credit card) (Steps S31 and S32).

Next, the checking unit 12 makes inquiry to the financial institution server 40 and checks the amount of advance payment by the user (Step S33; checking step). Then, the setting unit 14 sets the limit amount for the prepaid function based on the advance payment (Step S34; setting step). After that, the switching unit 16 updates the card information in the database 20 and thereby switches a payment means corresponding to the card number from credit to prepaid (Step S35). Further, the notification unit 15 transmits a prepaid settings notification to the user terminal Tu (Step S36, notification step).

As described above, in this embodiment also, the limit amount corresponding to a card number is set to be equal to or less than the amount of advance payment by a user, and a message indicating that the setting is done is notified to the applicant. Accordingly, the applicant can use the card number as a prepaid payment means within the limit amount. For example, a user for whom the credit function is suspended can continue to use the card number as a prepaid payment means as long as making advance payment. On the other hand, because the limit amount is secured by the advance payment by the user, a risk for a credit card company is reduced.

The ID management device 10 may notify a user of a message indicating that the credit function is about to become suspended (the card number is about to become invalid) and that switching to the prepaid function is possible, before suspending the credit function (before updating the status flag to “unavailable”). If the ID management device 10 includes an advance notification unit that executes such processing, it is possible to prompt a user to make advance payment and set the prepaid function.

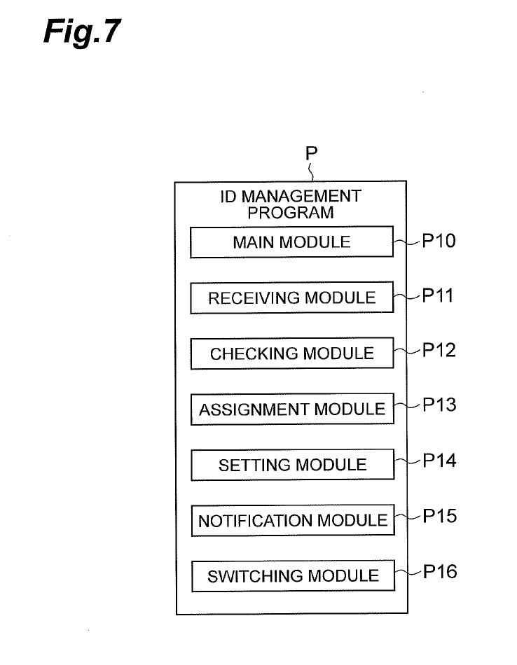

An ID management program P that causes a computer to function as the ID management device 10 according to the first or second embodiment is described hereinafter with reference to FIG. 7.

The ID management program P includes a main module P10, a receiving module P11, a checking module P12, an assignment module P13, a setting module P14, a notification module P15, and a switching module P16

The main module P10 is a part that exercises control over the management of a card number. The functions implemented by executing the receiving module P11, the checking module P12, the assignment module P13, the setting module P14, the notification module P15 and the switching module P16 are equal to the functions of the receiving unit 11, the checking unit 12, the assignment unit 13, the setting unit 14, the notification unit 15 and the switching unit 16 described above, respectively.

The ID management program P is provided in the form of being recorded in a static manner on a tangible recording medium such as CD-ROM or DVD-ROM or semiconductor memory, for example. Further, the ID management program may be provided as a data signal superimposed onto a carrier wave through a communication network.

Embodiments of the present invention are described in detail above. However, the present invention is not limited to the above-described embodiments. Various changes and modifications may be made to the present invention without departing from the scope of the invention.

### REFERENCE SIGNS LIST

1 . . . ID management system, 10 . . . ID management device, 11 . . . receiving unit, 12 . . . checking unit, 13 . . . assignment unit, 14 . . . setting unit, 15 . . . notification unit, 16 . . . switching unit, 20 . . . database (storage unit), 30 . . . payment processing device, 40 . . . financial institution server, P . . . management program, P10 . . . main module, P11 . . . receiving module, P12 . . . checking module, P13 . . . assignment module, P14 . . . setting module, P15 . . . notification module, P16 . . . switching module, Ts . . . member shop terminal, Tu . . . user terminal

1-11. (canceled)

12. An ID management system comprising:
an acquisition unit configured to acquire an amount of advance payment made by a user when applying for use of a postpaid service based on credit;
a generation unit configured to generate an ID identifying the user having paid the amount of advance payment acquired by the acquisition unit in the postpaid service;
a registration unit configured to register data where an available amount determined based on the amount of advance payment acquired by the acquisition unit and the ID generated by the generation unit are associated;
a notification unit configured to notify, before credit examination on the user is completed, the user of the ID to enable payment with a prepaid service within the available amount corresponding to the ID generated by the generation unit; and
a processing unit configured to perform, when credit is granted to the user by the credit examination on the user, processing for enabling use of the postpaid service based on the credit and corresponding to the ID generated by the generation unit.

13. The ID management system according to claim 12, wherein
the processing unit makes switching from the prepaid service to the postpaid service.

14. The ID management system according to claim 12, wherein
the registration unit registers the data where the ID, the available amount, a credit limit for the postpaid service, and a flag indicating the prepaid service or the postpaid service are associated into a storage unit.

15. The ID management system according to claim 14, further comprising:
a comparison unit configured to acquire the ID and an inquiry amount, acquire the flag corresponding to the ID by accessing the storage unit, and, when the flag indicates the prepaid service, compare the inquiry amount with the available amount.

16. An ID management method executed in an ID management system including a processor, comprising:
an acquisition step of acquiring an amount of advance payment made by a user when applying for use of a postpaid service based on credit;
a generation step of generating an ID identifying the user having paid the amount of advance payment acquired in the acquisition step in the postpaid service;
a registration step of registering data where an available amount determined based on the amount of advance payment acquired in the acquisition step and the ID generated in the generation step are associated;
a notification step of notifying, before credit examination on the user is completed, the user of the ID to enable payment with a prepaid service within the available amount corresponding to the ID generated in the generation step; and
a processing step of performing, when credit is granted to the user by the credit examination on the user, processing for enabling use of the postpaid service based on the credit and corresponding to the ID generated in the generation step.
